(19) United States
(12) Patent Application Publication
(10) Pub. No.: US 2023/0328595 A1
(43) Pub. Date: Oct. 12, 2023

(54) WIRELESS COMMUNICATION SYSTEM LINKING METHOD AND WIRELESS COMMUNICATION SYSTEM CONTROLLER

(71) Applicant: NIPPON TELEGRAPH AND TELEPHONE CORPORATION, Tokyo (JP)

(72) Inventors: Shota NAKAYAMA, Musashino-shi, Tokyo (JP); Daisuke MURAYAMA, Musashino-shi, Tokyo (JP); Kenichi KAWAMURA, Musashino-shi, Tokyo (JP); Takatsune MORIYAMA, Musashino-shi, Tokyo (JP)

(73) Assignee: NIPPON TELEGRAPH AND TELEPHONE CORPORATION, Tokyo (JP)

(21) Appl. No.: 18/022,265

(22) PCT Filed: Aug. 25, 2020
(86) PCT No.: PCT/JP2020/032078

§ 371 Date: Feb. 20, 2023

(51) Int. Cl. H04W 36/00; H04W 36/14

(52) U.S. Cl. CPC H04W 36/00222; H04W 36/1446

(57) ABSTRACT

The present disclosure provides a wireless communication system cooperation method appropriate for cooperation between a mobile communication system and a wireless LAN system involving priority control. In a communication area of 5G, a 5QI representing communication quality is allocated to a service data flow, and the communication of the service data flow is performed via a base station so that the communication quality is realized. A priority condition corresponding to 5QI is set for a frequency resource of the wireless LAN (step 100). When the wireless terminal UE to be protected is handed over to the wireless LAN (step 102), a priority condition set based on 5QI is instructed to the access point (step 106). Thereafter, the access point performs communication of the service data flow according to the priority condition.

### TECHNICAL FIELD

The present disclosure relates to a wireless communication system cooperation method and a wireless communication system control device, and more particularly, to a wireless communication system cooperation method and a wireless communication system control device appropriate for cooperation between a mobile communication system and a wireless LAN system involving priority control.

### BACKGROUND ART

In recent years, general use of 5th generation (hereinafter referred to as “5G”) mobile communication services has started. The details of 5G are disclosed in, for example, NPL 1.

As 5G communication services, a local 5G (hereinafter referred to as “L5G”) service developed locally in a specific building or site by a district or an enterprise is known in addition to a service developed nationwide by a communication service provider. Hereinafter, in the present specification, “5G” includes “L5G” without distinguishing between the two in the following description.

The 5G communication service can provide high quality wireless access, but a large cost is incurred for introduction and maintenance management of a communication system. Therefore, it is not always easy to cover the entire area of a desired service area by a 5G communication system.

A wireless LAN system is known as a wireless communication system which can be introduced at relatively low cost. For example, NPL 2 discloses the details of IEEE 802.11ax, called WiFi6.

When an area which cannot be covered by 5G is complemented by a wireless LAN, disconnection of local communication can be avoided while suppressing an increase in cost. When the 5G communication system and a wireless LAN communication system are closely cooperating, high quality wireless access can be provided over an entire wide area.

### CITATION LIST

### Non Patent Literature

[NPL 1] 3 GPP TS 23.501 V16.4.0 (2020-03) (Release 16)

[NPL 2] IEEE P802.11axTM/D6.0 Draft Standard for Information technology-Telecommunications and information exchange between systems Local and metropolitan area networks-Specific requirements, Part 11: Wireless LAN Medium Access Control (MAC) and Physical Layer (PHY) Specifications, November 2019:

### SUMMARY OF INVENTION

### Technical Problem

Incidentally, in a wireless LAN system, independent distributed control by Carrier Sense multiple Access/Collision Avoidance (CSMA/CA) is used as a standard scheme. In this case, each terminal connected to an access point (AP) of a wireless LAN performs carrier sense and performs communication when vacancy of the wireless channel is checked. When the number of wireless terminals increases, a communication time allocated to each terminal is reduced and desired communication quality may not be maintained Therefore, it is difficult to continuously provide high-quality communication by merely complementing an out-of-service area of mobile communication with a wireless LAN of the related art.

The present disclosure has been finalized to solve the above-described problem and a first objective of the present disclosure is to provide a wireless communication system cooperation method capable of maintaining desired communication quality even in a communication section with a wireless LAN by allowing favorable cooperation of mobile communication involving priority control with the wireless LAN.

A second objective of the present disclosure is to provide a control device of a wireless communication system capable of maintaining desired communication quality even in a communication section with a wireless LAN by allowing favorable cooperation of mobile communication involving priority control and the wireless LAN.

### Solution to Problem

According to a first aspect, to achieve the foregoing objectives, a wireless communication system cooperation method preferably includes: a mobile communication step of exchanging a service data flow between a data network and a wireless terminal via a base station of mobile communication; a step of detecting handover of the wireless terminal from the mobile communication to the wireless LAN and reverse handover of the wireless terminal; and a wireless LAN communication step of exchanging the service data flow between the data network and the wireless terminal via an access point of the wireless LAN until the wireless terminal is handed over to the wireless LAN and is subsequently handed over to the mobile communication. The mobile communication step includes a step of allocating an indicator indicating communication quality to the service data flow and a step of communicating the service data flow between the data network and the wireless terminal via the base station so that communication quality corresponding to the indicator is realized. The wireless LAN communication step includes a priority control setting step of setting a frequency resource of the wireless LAN to be allocated to the wireless terminal handed over to the wireless LAN based on the indicator, a step of communicating the service data flow between the data network and the wireless terminal via the access point in accordance with the setting after the wireless terminal is handed over to the wireless LAN, and a step of releasing the setting when the wireless terminal is handed over to the mobile communication.

According to a second aspect, a wireless communication system control device controls cooperation between a mobile communication system exchanging a service data flow between a data network and a wireless terminal via a base station of mobile communication and a wireless LAN communication system exchanging the service data flow between the data network and the wireless terminal via an access point of a wireless LAN. The wireless communication system control device preferably includes: a communication interface unit configured to enable communication with a core network of the mobile communication and the access point; an information collection unit configured to collect information regarding handover of the wireless terminal from the mobile communication to the wireless LAN and reverse handover of the wireless terminal and information regarding an indicator allocated to the service data flow to represent communication quality required in the mobile communication via the communication interface unit; a wireless LAN priority control setting unit configured to set a frequency resource of the wireless LAN to be allocated to the wireless terminal handed over to the wireless LAN based on the indicator; and a wireless LAN priority control instruction unit configured to instruct the access point to perform setting by the wireless LAN priority control setting unit when the wireless terminal is handed over to the wireless LAN and to release the setting when the wireless terminal is handed over to the mobile communication.

### Advantageous Effects of Invention

According to the first or second aspects, in mobile communication, a service data flow is exchanged between a data network and a wireless terminal so that communication quality indicated by an indicator is guaranteed. Accordingly, desired communication quality can consequently be obtained in this case. In a wireless LAN, a communication resource of the wireless LAN in charge of communication between the data network and the wireless terminal is set based on the indicator. Therefore, according to an aspect of the present disclosure, communication quality comparable to that of mobile communication can be stably maintained even by the wireless LAN.

### BRIEF DESCRIPTION OF DRAWINGS

FIG. 1 is a diagram illustrating an example of an area covered by a 5G communication system and a wireless LAN communication system.

FIG. 2 is a diagram illustrating comparison between two communication methods used for a wireless LAN.

FIG. 3 is a diagram illustrating a communication failure occurring when priority control is not performed in the wireless LAN.

FIG. 4 is a diagram illustrating an aspect in which communication quality deteriorates in an area of the wireless LAN.

FIG. 5 is a diagram illustrating an overall communication system according to the present disclosure.

FIG. 6 is a block diagram illustrating an example of a configuration for realizing the communication system according to the present disclosure.

FIG. 7 is a diagram illustrating an overview of a QoS flow in 5G.

FIG. 8 is a table for describing QoS (5QI) used for 5G.

FIG. 9 is a diagram illustrating an overview of priority control performed in a wireless LAN according to the present disclosure.

FIG. 10 is a diagram illustrating a conversion example of the priority control when a terminal is handed over from 5G to a wireless LAN.

FIG. 11 is a diagram illustrating an example of setting of a wireless LAN used under the priority control.

FIG. 12 is a diagram illustrating an operation when the priority control is performed in a wireless LAN.

FIG. 13 is a diagram illustrating an aspect in which communication quality in an area of a wireless LAN is improved by performing the priority control.

FIG. 14 is a block diagram illustrating a functional configuration of a control device according to the present disclosure.

FIG. 15 is a flowchart of processing of the priority control performed by the control device according to the present disclosure.

FIG. 16 is a block diagram illustrating another example of the configuration for realizing the wireless communication system according to the present disclosure.

### DESCRIPTION OF EMBODIMENTS

### First Embodiment

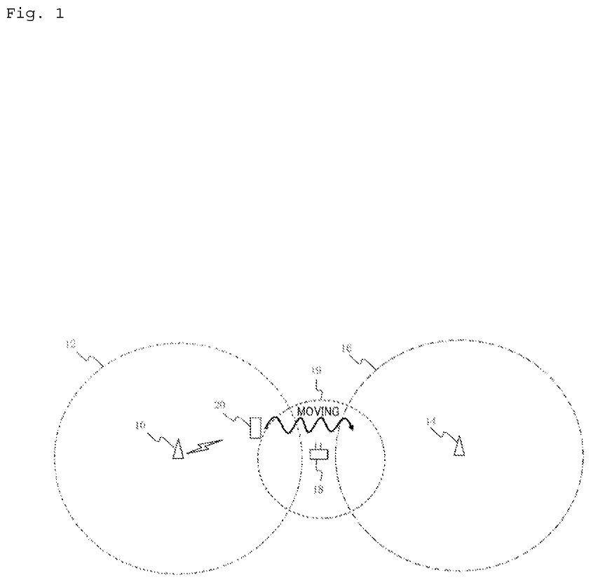

FIG. 1 illustrates an example of an area covered by a mobile communication system and a wireless LAN communication system. The mobile communication system is assumed to be a 5G communication service in conformity with the 5th generation standard. In the example illustrated in FIG. 1, a first base station 10 is included. The first base station 10 has a radio wave coverage range 12. In the example illustrated in FIG. 1, a second base station 14 in conformity with 5G is further included. The second base station 14 has a radio wave coverage range 16.

The radio wave coverage range 12 of the first base station 10 and the radio wave coverage range 16 of the second base station 14 do not overlap each other, and there is an out-of-service area of 5G between both the ranges. In the example illustrated in FIG. 1, an access point AP 18 of the wireless LAN is installed to cover the out-of-service area. The AP 18 conforms to the IEEE 802.11ax standard, that is, the so-called WiFi6 standard.

In the example illustrated in FIG. 1, a wireless terminal 20 is moving from the radio wave coverage range 12 of the first base station 10 to the radio wave coverage range 16 of the second base station 14 via a communication area 19 of the AP 18. In this case, the wireless terminal 20 can perform communication in conformity with 5G while the wireless terminal 20 belongs to the radio wave coverage range 12 and after the wireless terminal 20 enters the radio wave coverage range 16. In order to continuously obtain good communication quality during the movement, it is important to maintain communication quality comparable to 5G between the wireless terminal 20 and the AP 18.

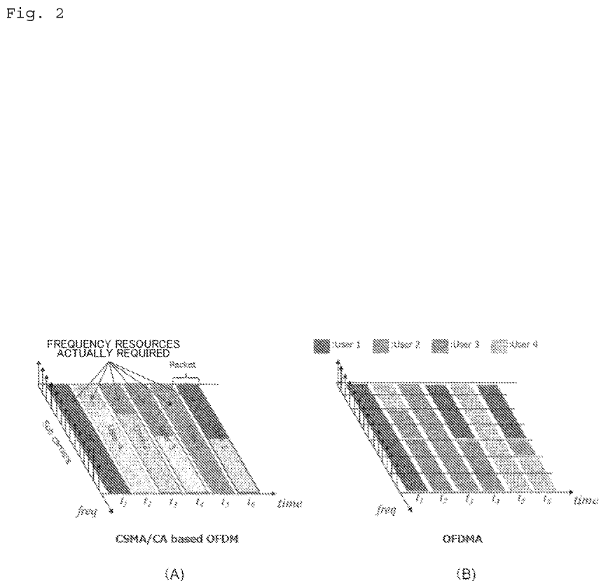

FIG. 2(A) illustrates a communication method for a wireless LAN used in IEEE 802.ac which is a standard previous to WiFi6. In this communication method, Users (wireless terminals) 1 to 4 belonging to a communication area of the wireless LAN perform carrier sense, and perform communication in a time division manner so that collision does not occur in communication. In this case, each of Users 1 to 4 performs communication using a desired number of subcarriers among a plurality of subcarriers partitioned at a prescribed frequency width. In this case, the frequency resources actually required in each time slot may become a part of the entire frequency resources illustrated in the drawing.

FIG. 2(B) is a diagram illustrating a communication method used for WiFi6. In WiFi6, available subcarriers are allocated to a plurality of users for each time slot. In this case, the entire available frequency resources are effectively utilized in each of the time slots, as illustrated in the drawing. Therefore, according to the WiFi6 method, high communication quality can be easily maintained under a situation in which there are many users, compared to a previous method.

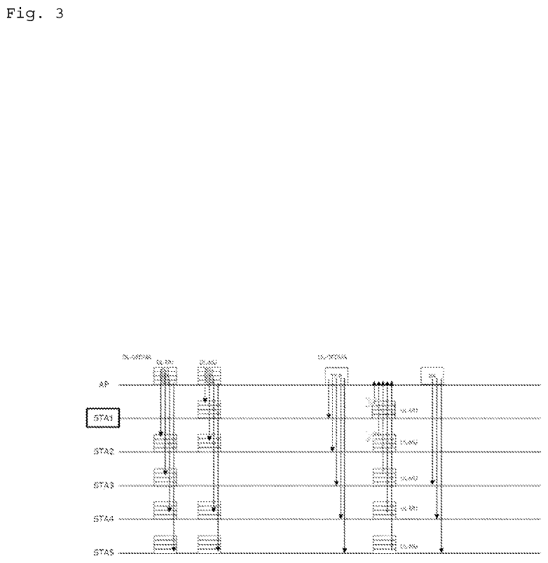

FIG. 3 illustrates an example of a timing chart when five wireless terminals STA1 to STA5 perform uplink (UL) and downlink (DL) communication with an AP in conformity with WiFi6 according to an OFDMA scheme. Here, it is assumed that the STA1 is a wireless terminal which is in guaranteed bit rate protection in 5G communication.

An indication of “DL-OFDMA” illustrated in the top left of FIG. 3 means downlink communication in conformity with an OFDMA scheme. An indication of “DL-MU” means downlink multiuser communication in which data is transmitted simultaneously to a plurality of wireless terminals in the same time slot. When the number of available resource units (RUs) is four of RU1-RU4, data cannot be transmitted simultaneously to all the five terminals STA1 to STA5.

Therefore, when allocation of the RUs is determined at random, the RU is not allocated to the terminal STA1 to be protected, as illustrated in the drawing, and desired communication may not be performed in the STA1.

An indication of “UL-OFDMA” illustrated in the top center of FIG. 3 means uplink communication in conformity with an OFDMA scheme. An indication of “UL-MU” means uplink multiuser communication. In rules of WiFi6, a trigger frame (TR-R) is transmitted from the AP to the wireless terminals STA1 to STA5 earlier than the uplink of data. The wireless terminals STA1 to STA5 receiving the trigger frame simultaneously transmit the data to the AP by using different RUs. Here, when the number of available RUs is smaller than the number of wireless terminals, the RU used by the STA1 and the RU used by another wireless terminal (STA2) may overlap each other In this case, data of the STA1 collides with data of the STA2 and the STA1 may not perform desired communication.

The AP receiving the uplink data returns an acknowledge signal (BA: Block Acknowledge) to all the wireless terminals which are transmission sources of the received data. Thus, the STA3 to the STA5 can detect a success of data transmission.

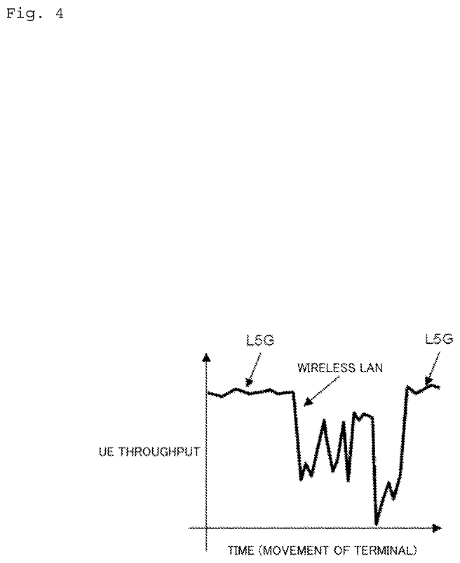

FIG. 4 illustrates an aspect in which a throughput considerably deteriorates in a communication area of a wireless LAN when the wireless terminal STA1 moves on the route illustrated in FIG. 1. As illustrated in FIG. 4, even when a wireless LAN in conformity with WiFi6 is introduced, the communication quality of the STA1 to be protected may considerably deteriorate in the communication area of the wireless LAN when simply performing handover between the 5G communication system and the wireless LAN communication system.

### Configuration of First Embodiment

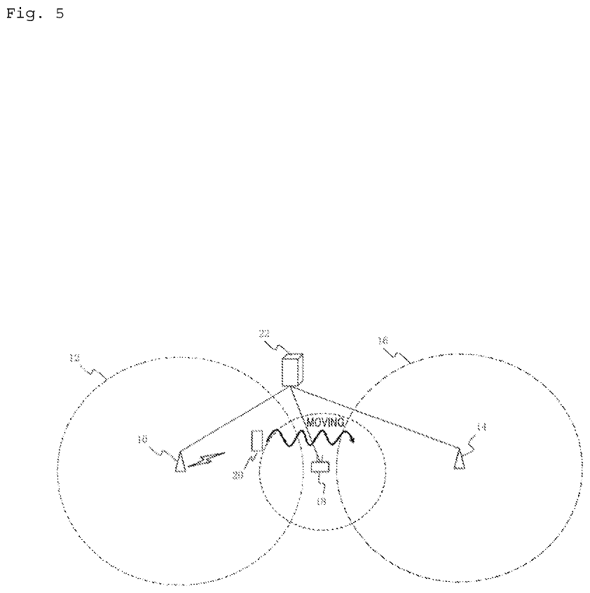

FIG. 5 is a diagram illustrating an overall communication system according to the first embodiment of the present disclosure. In FIG. 5, the same units as those of the units illustrated in FIG. 1 are denoted by the same reference signs, and description thereof is omitted or simplified. As illustrated in FIG. 5, the communication system according to the embodiment includes a control device 22. The control device 22 can exchange information and instructions with each of the first base station 10, the second base station 14, and the AP 18.

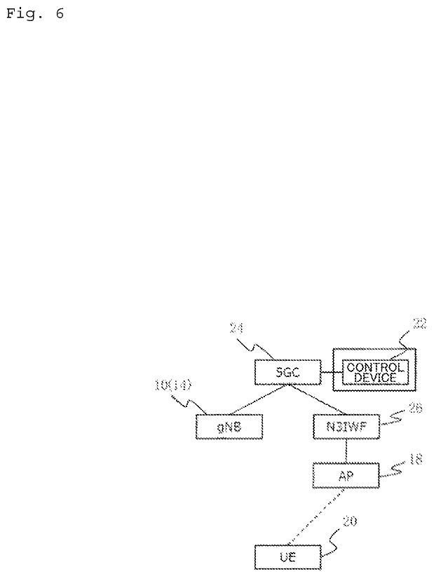

FIG. 6 is a functional block diagram illustrating the communication system illustrated in FIG. 5. As illustrated in FIG. 6, the control device 22 is connected to a 5G core network (5GC) 24. A 5G base station gNB forming a 5G access network is connected to the 5GC 24. The base station gNB corresponds to the first base station 10 and the second base station 14 illustrated in FIG. 1 or 5.

The 5GC 24 is further connected to a non-3GPP Inter-working function (N3IWF) 26. The N3IWF is a device that supports connection to 5G via a non-3GPP access network such as a wireless LAN. The AP 18 is connected to the N3IWF 26. Then, the wireless terminal 20 belonging to the communication area of the AP 18 can obtain connection with the 5GC via the AP 18 and the N3IWF.

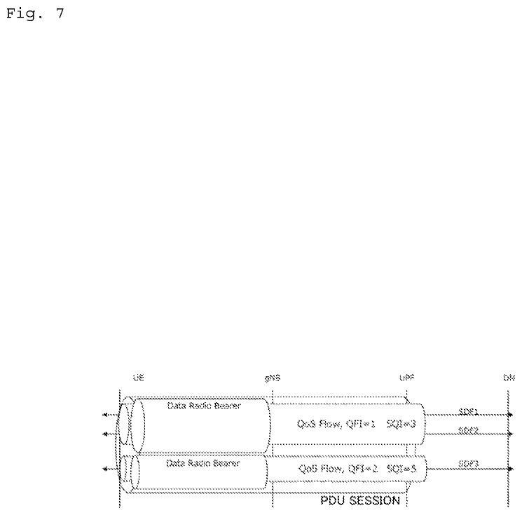

FIG. 7 illustrates an overview of the quality of service (QoS) control in 5G. FIG. 7 illustrates a state in which three service data flows SDF1 to SDF3 are established between one wireless terminal (UE) and the data network (DN) in 5G communication. The SDF1 to the SDF3 are, for example, data flows used for different applications.

In 5G, when a plurality of SDFs are established for one wireless terminal UE, a QoS flow can be set in each SDF. Each identifier QoS flow identifier (QFI) is allocated to the QoS flow. The allocation of the QFI is determined based on a priority control policy in a user plane function (UPF) which is a part of the 5GC 24 or a wireless terminal UE. In the example illustrated in FIG. 7, the SDF1 and the SDF2 are taken in the same QoS flow, and the QFI=1 is allocated to the QoS flow. The SDF3 is taken in the QoS flow to which the QFI=2 is allocated.

In FIG. 7, a wired section is made between the base station gNB and the UPF. In the wired section, a value of 5QI which is a QoS indicator defined by 5G is mapped to the QFI. In FIG. 7, a wireless section is made between the wireless terminal UE and the base station gNB. In this wireless section, a data radio bearer (DRB) is allocated for each QoS flow and the 5QI is mapped to the DRB. In the example illustrated in FIG. 7, the 5QI=3 is mapped to the QoS flow of the QFI=1 and the 5QI=5 is mapped to the QoS flow of the QFI=2. The mapping is performed on the flow of the downlink (DL) by the UPF. On the other hand, the UE performs mapping on the flow of the uplink (UL). The mapping in the UE is performed by setting the QFI of the DL in the UL of the same flow.

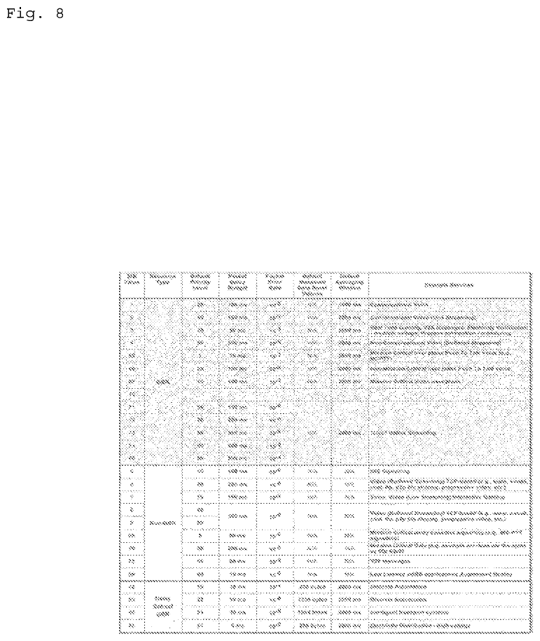

FIG. 8 is a table illustrating combinations of 5QI values and QoS features corresponding thereto. As illustrated in FIG. 8, for example, whether a resource type is a guaranteed bit rate (GBR), a non-guaranteed bit rate (non-GBR), or a delay critical GBR is determined with the 5QI value. Further, a priority level, a packet delay budget, a packet error rate, a maximum data burst amount, or an averaging window, and service example are determined with the 5QI value. In the 5G communication, communication of each SDF is performed so that QoS features determined by the 5QI are satisfied.

### Features of First Embodiment

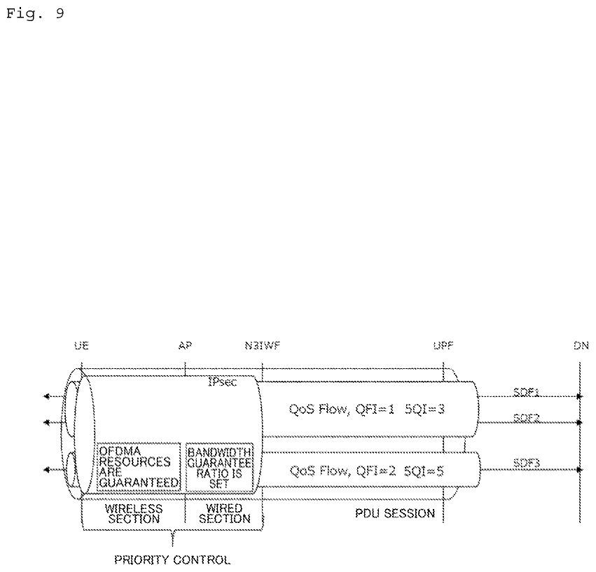

FIG. 9 is a diagram illustrating the overview of priority control performed after the wireless terminal 20 is handed over from 5G to the wireless LAN in the embodiment. As illustrated in FIG. 9, in the embodiment, information regarding the QFI and the 5QI allocated by 5G (see the indications between the N3IWF and the UPF) is also used for the wireless LAN. In the embodiment, there are features in that priority control is performed based on the QFI in a wireless LAN network section between the UE and the N3IWF.

In FIG. 9, a wireless section is made between the UE and the AP. In the embodiment, in this section, the priority control is realized by fixedly allocating the resource unit RUs of OFDMA in accordance with 5QI. When there are a plurality of QoS flows for one UE and a plurality of 5QI are set, the RUs are fixedly allocated in accordance with the 5QI with the highest priority.

In FIG. 9, a wired section is made between the AP and the N3IWF. In this embodiment, priority control is realized by fixedly associating the bandwidth guarantee ratio in accordance with 5QI in this section. As in the case of the wireless section, when there are a plurality of QoS flows for one UE, the bandwidth guarantee ratio is set based on the 5QI with the highest priority.

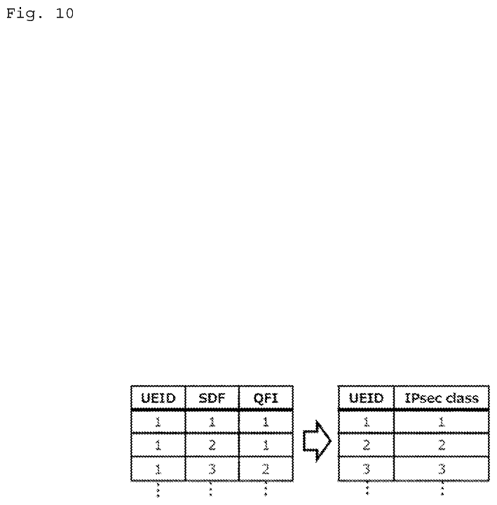

FIG. 10 illustrates an aspect in which an IPsec class is set for each wireless terminal UE in association with handover from 5G to the wireless LAN. Here, a data flow including the SDF1 and the SDF3 is included in the wireless terminal of the UEID=1, and the QFI=1 or 2 is allocated to the flow. When priority of the QFI=1 is higher than that of the QFI=2, the IPsec class for the wireless terminal of the UEID=1 is allocated based on the QFI=1. As a result, in FIG. 10, the IPsec class=1 is allocated to the wireless terminal having the UEID=1. FIG. 10 illustrates an example in which the IPsec class=2 is allocated to the wireless terminal of the UEID=2, and the IPsec class=3 is allocated to the wireless terminal of the UEID=3 through similar processing.

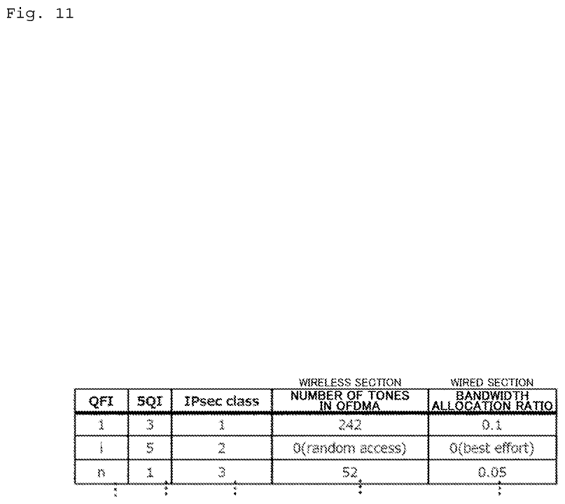

FIG. 11 illustrates a relation between QFI and IPsec class features determined in accordance with the setting illustrated in FIG. 10. In FIG. 11, the number of tones of OFDMA=242 and a bandwidth allocation ratio=0.1 are set for IPsec class=1. According to this setting, in QFI=1 to which the IPsec class=1 is allocated, transmission of a wireless section in which 242 RUs are used fixedly and transmission of a wired section at a bandwidth allocation ratio=0.1 are performed.

In the QFI=i to which the IPsec class=2 is allocated, the transmission of the wireless section in the RU obtained by random access and the transmission of the wired section in accordance with the best effort policy are fixedly performed. Further, in the QFI=n to which the IPsec class=3 is allocated, transmission of a wireless section in which 52 RUs are used and transmission of a wireless section at a bandwidth allocation ratio=0.05 are fixedly performed. The transmission qualities match the priority of 5QI allocated to the QFI. Thus, according to the embodiment, the priority control performed in 5G can be reflected in the communication quality of the wireless LAN.

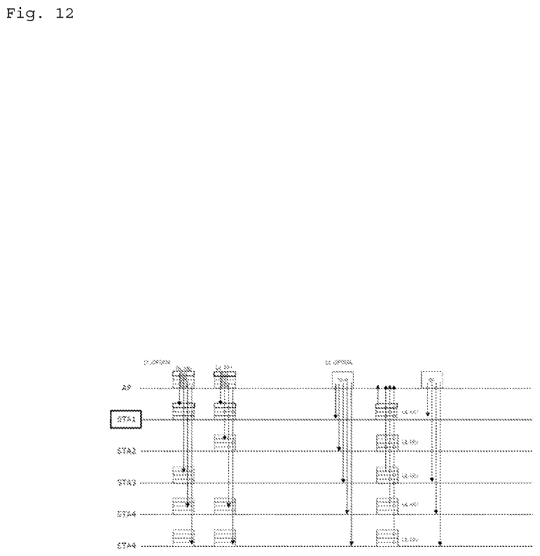

FIG. 12 is a timing chart illustrating an operation when the foregoing priority control is performed in a wireless LAN. In this example, RU1 is fixedly allocated to the wireless terminal STA1 to be protected. Thus, the STA1 can constantly receive data from the AP at a communication timing of DL-MU. The STA1 can constantly transmit data to the AP even at a communication timing of UL-MU. Further, according to this control, data collision in UL-MU is avoided. Therefore, an improvement of the communication efficiency as a whole can be realized in addition to maintenance of communication quality of the STA1.

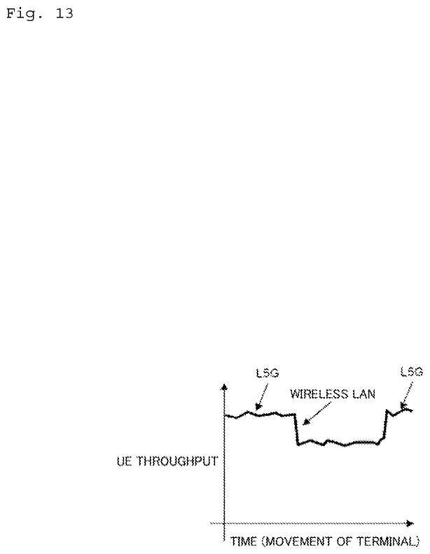

FIG. 13 illustrates an aspect in which a stable throughput can be guaranteed even in a communication area of the wireless LAN as a result of the foregoing priority control. Priority control is fixedly performed on wireless terminals to be protected. Therefore, even when the number of wireless terminals in the communication area of the wireless LAN increases, the communication quality is maintained stably and satisfactorily. Thus, according to the embodiment, the priority control of 5G and the priority control of the wireless LAN can be appropriately cooperated.

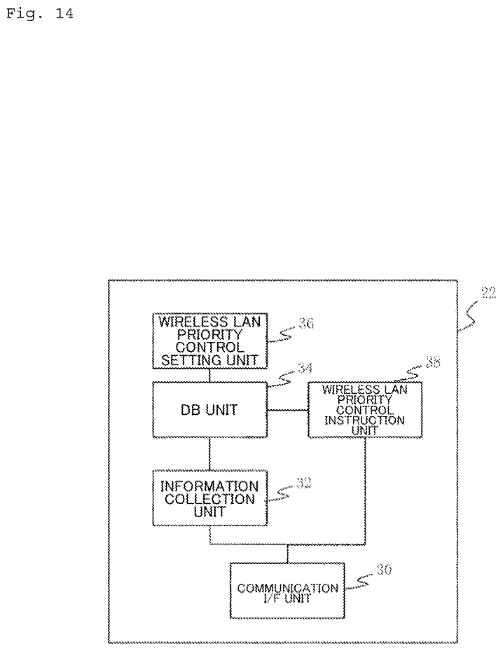

FIG. 14 is a block diagram illustrating a functional configuration of the control device 22 according to the embodiment. The control device 22 is a server realized by combining software with hardware such as various interfaces, a memory device, and an arithmetic device. The functions can be represented as illustrated in FIG. 14.

As illustrated in FIG. 14, the control device 22 includes a communication interface unit 30. The control device 22 can communicate with the 5GC 24 via the communication interface unit 30.

The communication interface unit 30 can provide information obtained from the 5GC 24 to an information collection unit 32. Specifically, the information collection unit 32 collects information regarding handover of the wireless terminal UE between 5G and the wireless LAN. The information collection unit 32 collects QoS information for each application for each wireless terminal UE.

The information collected by the information collection unit 32 is stored in a database unit 34. The database unit 34 can provide the stored information to a wireless LAN priority control setting unit 36.

The wireless LAN priority control setting unit 36 sets priority conditions in each of a wireless section and a wired section of the wireless LAN in association with the 5QI with the highest priority in each wireless terminal UE. More specifically, as described with reference to FIGS. 9 to 11, the number of tones in OFDMA (allocation of the RUs) is set in association with 5QI, and the bandwidth allocation ratio of the wired section is set.

The control device 22 further includes a wireless LAN priority control instruction unit 38. When the UE is handed over from the 5G to the wireless LAN, the wireless LAN priority control instruction unit 38 provides priority information regarding the UE to the AP 18 via a communication interface unit 30. Specifically, for an application of the UE handed over to the wireless LAN, an instruction is provided to the AP 18 to ensure the set resource unit RU and the bandwidth allocation ratio.

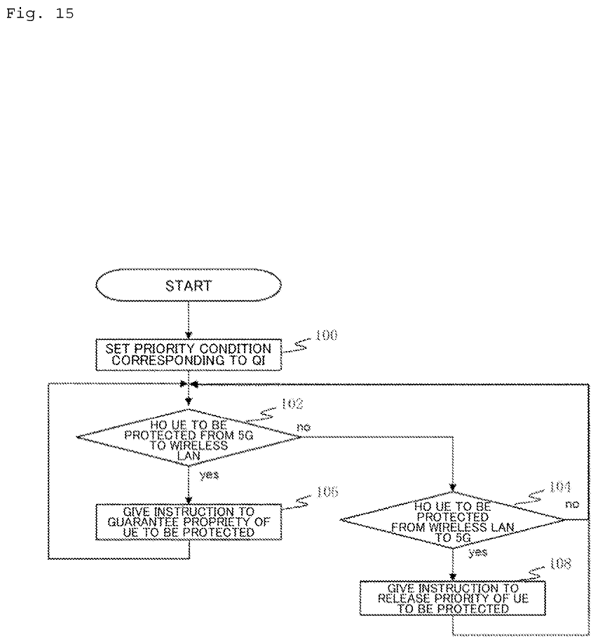

FIG. 15 is a flowchart illustrating processing performed by the control device 22 to realize the foregoing functions. According to this routine, the control device 22 first sets a priority condition corresponding to 5QI for each application in the UE which is performing communication in 5G (step 100). Specifically, the number of tones in OFDMA to be allocated to the wireless LAN and the bandwidth allocation ratio in a priority section are set.

Subsequently, it is determined whether the wireless terminal UE to be protected is handed over from 5G to the wireless LAN (step 102).

When it is determined that the handover has not occurred, it is subsequently determined whether the wireless terminal UE to be protected is a handed over from the wireless LAN to 5G (step 104).

When the handover is not recognized, the processing after step 102 is repeated again. Then, when the handover from 5G to the wireless LAN is recognized in step 102, an instruction to guarantee priority communication of the wireless terminal UE to be protected is subsequently given to the AP 18 (step 106).

While the UE to be protected stays in an area of the wireless LAN, the processing of steps 102 and 104 are repeated. When the UE goes out of the communication area of the wireless LAN and is handed over to 5G, the handover is recognized in step 104. In this case, an instruction to release priority for the UE to be protected is subsequently given to the AP 18 (step 108).

The AP 18 receives the foregoing instruction and performs fixed priority control on the UE to be protected. Thus, according to the embodiment, as described with reference to FIGS. 12 and 13, communication quality comparable to 5G can be stably guaranteed for the UE to be protected even in the area of the wireless LAN.

### Modified Example of First Embodiment

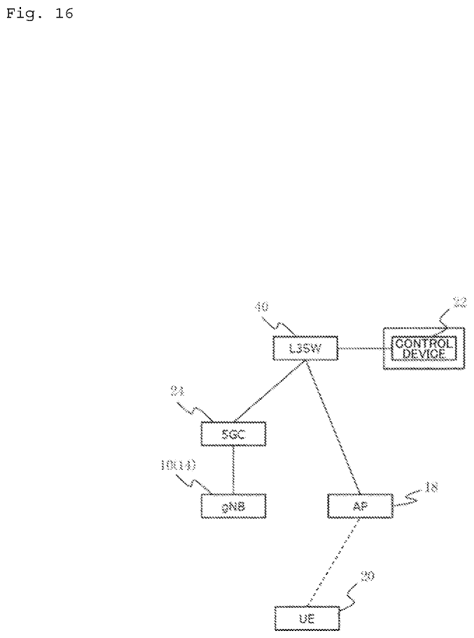

Incidentally, while the AP 18 is connected to the N3IWF 26 in the above-described first embodiment, the configuration thereof is not limited to this. For example, as illustrated in FIG. 16, the AP 18 may be deployed in another network via an L3SW 40.

While the mobile communication service is limited to the 5G service in the above-described first embodiment, the present invention is not limited to this. The present invention can be widely applied to mobile communication services for performing priority control on a wireless terminal to be protected. Similarly, in the first embodiment, the communication system of the wireless LAN is limited to WiFi6, but the application of the present invention is not limited to this. The present invention can be widely applied to a wireless LAN system capable of preferentially allocating communication resources to a wireless terminal to be protected.

In the above-described first embodiment, the number of tones in OFDMA is fixedly allocated to the wireless terminal to be protected which is handed over to the wireless LAN and the bandwidth allocation ratio is fixedly assigned. The number of tones ratio to be allocated and the bandwidth allocation may be uniquely determined for 5QI, but they may be dynamically set in preparation for a case in which there are a plurality of terminals to be protected at the same time. In this case, it is desirable to determine the priority of each wireless terminal based on 5QI so that all the wireless terminals to be protected are prioritized appropriately and to set the number of tones and the bandwidth allocation ratio to be given to each protection target according to the priority.

In the above-described first embodiment, the priority control is realized by preferentially allocating the number of tones in OFDMA and the bandwidth allocation ratio to the wireless terminal to be protected. However, targets to be allocated for the priority control is not limited to the number of tones and the bandwidth allocation ratio and can be widely used as long as resources are required for communication of the wireless LAN.

Further, in the above-described first embodiment, one type of priority control is performed on one UE after the UE is handed over to the wireless LAN. However, the application of the present invention is not limited thereto. Priority control different for each SDF may be performed after the UE is handed over to the wireless LAN as long as a function of the wireless LAN is possible.

### REFERENCE SIGNS LIST

10 First base station
14 Second base station
18 AP
20, STA1, STA2, STA3, STA4, STA5 UE Wireless terminal
22 Control device
30 Communication interface unit
32 Information collection unit
34 Database unit
36 Wireless LAN priority control setting unit
38 Wireless LAN priority control instruction unit

1. A wireless communication system cooperation method comprising:
a mobile communication step of exchanging a service data flow between a data network and a wireless terminal via a base station of mobile communication;
a step of detecting handover of the wireless terminal from the mobile communication to the wireless LAN and reverse handover of the wireless terminal; and
a wireless LAN communication step of exchanging the service data flow between the data network and the wireless terminal via an access point of the wireless LAN until the wireless terminal is handed over to the wireless LAN and is subsequently handed over to the mobile communication,
wherein the mobile communication step includes
a step of allocating an indicator indicating communication quality to the service data flow, and
a step of communicating the service data flow between the data network and the wireless terminal via the base station so that communication quality corresponding to the indicator is realized,
wherein the wireless LAN communication step includes
a priority control setting step of setting a frequency resource of the wireless LAN to be allocated to the wireless terminal handed over to the wireless LAN based on the indicator,
a step of communicating the service data flow between the data network and the wireless terminal via the access point in accordance with the setting after the wireless terminal is handed over to the wireless LAN, and
a step of releasing the setting when the wireless terminal is handed over to the mobile communication.

2. The wireless communication system cooperation method according to claim 1, wherein the mobile communication conforms to a 5th generation mobile communication standard,
wherein the indicator is a 5G QoS indicator, and
wherein the wireless LAN is WiFi6 in conformity with the IEEE 802.11ax standard.

3. The wireless communication system cooperation method according to claim 2, wherein the frequency resource is the number of tones of an OFDMA subcarrier in charge of communication of a wireless section between the wireless terminal and the access point.

4. The wireless communication system cooperation method according to claim 1,
wherein the priority control setting step further includes a step of setting a bandwidth allocation ratio to be guaranteed in a wired section between the access point and the data network for the wireless terminal handed over to the wireless LAN based on the indicator.

5. A wireless communication system control device controlling cooperation between a mobile communication system exchanging a service data flow between a data network and a wireless terminal via a base station of mobile communication and a wireless LAN communication system exchanging the service data flow between the data network and the wireless terminal via an access point of a wireless LAN, the wireless communication system control device comprising:
a communication interface unit configured to enable communication with a core network of the mobile communication and the access point;
an information collection unit configured to collect information regarding handover of the wireless terminal from the mobile communication to the wireless LAN and reverse handover of the wireless terminal and information regarding an indicator allocated to the service data flow to represent communication quality required in the mobile communication;
a wireless LAN priority control setting unit configured to set a frequency resource of the wireless LAN to be allocated to the wireless terminal handed over to the wireless LAN based on the indicator; and
a wireless LAN priority control instruction unit configured to instruct the access point to perform setting by the wireless LAN priority control setting unit when the wireless terminal is handed over to the wireless LAN and to release the setting when the wireless terminal is handed over to the mobile communication.

6. The wireless communication system control device according to claim 5, wherein the mobile communication conforms to a 5th generation mobile communication standard,
wherein the indicator is a 5G QoS indicator, and
wherein the wireless LAN is WiFi6 in conformity with the IEEE 802.11ax standard.

7. The wireless communication system control device according to claim 6, wherein the frequency resource is the number of tones of an OFDMA subcarrier in charge of communication of a wireless section between the wireless terminal and the access point.

8. The wireless communication system control device according to claim 5, wherein the wireless LAN priority control setting unit further sets a bandwidth allocation ratio to be guaranteed in a wired section between the access point and the data network for the wireless terminal handed over to the wireless LAN based on the indicator.
